(19) United States
(12) Patent Application Publication
(10) Pub. No.: US 2022/0303936 A1
(43) Pub. Date: Sep. 22, 2022

(54) NAS Counts for Multiple Wireless Connections

(71) Applicant: Apple Inc., Cupertino, CA (US)

(72) Inventors: Shu GUO, Beijing (CN); Dawei ZHANG, Saratoga, CA (US); Fangli XU, Beijing (CN); Haijing HU, Los Gatos, CA (US); Huarui LIANG, Beijing (CN); Yuqin CHEN, Beijing (CN)

(21) Appl. No.: 17/593,452

(22) PCT Filed: Oct. 29, 2020
(86) PCT No.: PCT/CN2020/124831

§ 371 Date: Sep. 19, 2021

(51) Int. Cl. H04W 60/06; H04W 76/10

(52) U.S. Cl. CPC H04W 60/06; H04W 76/10; H04W 84/042

(57) ABSTRACT

A user equipment (UE) establishes a first type of connection to a first public land mobile network (PLMN), the first type of connection having a first non-access stratum (NAS) Count pair corresponding to a first NAS security context associated with the first PLMN, establishes a second type of connection to a second PLMN, wherein a previous second type of connection was established with the first PLMN, wherein the previous second type of connection has a second NAS Count pair corresponding to the first NAS security context, wherein the second type of connection has a third NAS Count pair corresponding to a second NAS security context associated with the second PLMN and deregisters the previous second type of connection with the first PLMN to reset the second NAS count pair at the first PLMN.

### BACKGROUND

5G new radio (NR) wireless communications support multiple connections by a user equipment (UE) to a public land mobile network (PLMN). For example, a 3GPP connection (e.g., a 5G wireless connection) and a non-3GPP connection (e.g., a WiFi connection) may be established by a single UE. In such a scenario, the same security context in the packet data convergence protocol (PDCP) layer is used to encrypt the communications of both connections. One of the parameters input into the encryption algorithm is the non-access stratum (NAS) count. There is a NAS count for downlink (DL) communications and a NAS count for uplink (communications) on each connection. As such, for a UE having two connections (3GPP and non-3GPP), there are four NAS counts; a pair (DL and UL) of NAS counts for each connection.

### SUMMARY

Some exemplary embodiments are related to a user equipment (UE) having a transceiver configured to communicate with a plurality of networks and a processor communicatively coupled to the transceiver and configured to perform operations. The operations include establishing a first type of connection to a first public land mobile network (PLMN), the first type of connection having a first non-access stratum (NAS) Count pair corresponding to a first NAS security context associated with the first PLMN, establishing a second type of connection to a second PLMN, wherein a previous second type of connection was established with the first PLMN, wherein the previous second type of connection has a second NAS Count pair corresponding to the first NAS security context, wherein the second type of connection has a third NAS Count pair corresponding to a second NAS security context associated with the second PLMN and deregistering the previous second type of connection with the first PLMN to reset the second NAS count pair at the first PLMN.

Other exemplary embodiments are related to a user equipment (UE) having a transceiver configured to communicate with a plurality of networks and a processor communicatively coupled to the transceiver and configured to perform operations. The operations include establishing a first type of connection to a first public land mobile network (PLMN), wherein the first type of connection has a first non-access stratum (NAS) Count pair corresponding to a NAS security context associated with an access and mobility management function (AMF) of the first PLMN, reestablishing a second type of connection to the first PLMN after previously transitioning the second type of connection to a second PLMN and receiving a second NAS Count pair from an AMF of the first PLMN, wherein the second NAS count pair corresponds to the second type of connection.

Still further exemplary embodiments are related to a user equipment (UE) having a transceiver configured to communicate with a plurality of networks and a processor communicatively coupled to the transceiver and configured to perform operations. The operations include establishing a first type of connection to a first public land mobile network (PLMN), wherein the first type of connection has a first non-access stratum (NAS) Count pair corresponding to a NAS security context associated with the access and mobility management function (AMF) of the first PLMN, reestablishing a second type of connection to the first PLMN after previously transitioning the second type of connection to a second PLMN and determining a new security context for both the first type of connection and the second type of connection.

Additional exemplary embodiments are related to a user equipment (UE) having a transceiver configured to communicate with a plurality of networks and a processor communicatively coupled to the transceiver and configured to perform operations. The operations include establishing a first type of connection to a first public land mobile network (PLMN), wherein the first type of connection has a first non-access stratum (NAS) Count pair corresponding to a first NAS security context associated with the access and mobility management function (AMF) of the first PLMN, establishing a second type of connection to a second PLMN, wherein the second type of connection has a third NAS Count pair corresponding to a second NAS security context associated with the AMF of the second PLMN, wherein a previous second type of connection was with the first PLMN and included a second NAS Count pair corresponding to the first NAS security context and storing the first, second, and third NAS Count pairs.

Further exemplary embodiments are related to a network component implementing an access and mobility management function (AMF) of a core network that includes one or more processors configured to perform operations. The operations include receiving a request from a user equipment (UE) regarding deregistration of a first type of connection or a second type of connection between the UE and a first public land mobile network (PLMN) when the UE has transitioned the second type of connection from the first PLMN to a second PLMN and deregistering one of the first type of connection or second type of connection based on the request.

Some exemplary embodiments are also related to a network component implementing an access and mobility management function (AMF) of a core network including one or more processors configured to perform operations. The operations include receiving from a user equipment (UE) a request to reestablish a second type of connection to a first public land mobile network (PLMN) after the UE had previously transitioned the second type of connection to a second PLMN, and wherein the UE additionally has a first type of connection to the first PLMN and transmitting a NAS security mode command (SMC) including a second non-access stratum (NAS) Count pair to the UE, wherein the second NAS Count pair is associated with a NAS security context corresponding the first and second types of connections with the first PLMN.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIGS. 3A-3C show diagrams illustrating a UE establishing multi-connection access to PLMNs according to various exemplary embodiments.

FIG. 4 shows a method of managing a non-3GPP connection according to various exemplary embodiments.

FIG. 5 shows a method of managing a NAS Count pair associated with a non-3GPP connection according to various exemplary embodiments.

FIG. 6 shows a method of managing a UE's multi-connection access to a PLMN according to various exemplary embodiments.

FIG. 7 shows a method of managing a plurality of NAS Count pairs according to various exemplary embodiments.

### DETAILED DESCRIPTION

The exemplary embodiments may be further understood with reference to the following description and the related appended drawings, wherein like elements are provided with the same reference numerals. The exemplary embodiments describe manners for a user equipment (UE) to handle a multi-connection establishment with one or more public land mobile networks (PLMNs).

The exemplary embodiments are described with regard to a network that includes 5G new radio NR radio access technology (RAT). However, the exemplary embodiments may be implemented in other types of networks using the principles described herein.

The exemplary embodiments are also described with regard to a UE. However, the use of a UE is merely for illustrative purposes. The exemplary embodiments may be utilized with any electronic component that may establish a connection with a network and is configured with the hardware, software, and/or firmware to exchange information and data with the network. Therefore, the UE as described herein is used to represent any electronic component.

As noted above, a UE may establish a 3GPP connection (e.g., a 5G wireless connection) and a non-3GPP connection (e.g., a WiFi connection) with the same PLMN. Although both connections have the same security context and are encrypted using the same access and mobility management function (AMF) key, each connection is encrypted using a non-access stratum (NAS) Count pair, one NAS Count for the uplink (UL) and one NAS Count for the downlink (DL) on that connection.

Presently, the 3GPP standards (e.g., TS 31.102) allow for the storage of only one NAS Count pair per connection type on a universal subscriber identity module (USIM) of the UE. Consider the following scenario with this restriction. When a UE establishes a 3GPP and non-3GPP connection to a first PLMN, the UE stores a first NAS Count pair for the 3GPP connection and a second NAS Count pair for the non-3GPP connection. When the UE switches the non-3GPP connection to a second PLMN, a third NAS Count pair for this connection is established. The 3GPP connection to the first PLMN remains active. If, however, the UE attempts to reestablish the non-3GPP connection with the first PLMN, the AMF of the first PLMN will attempt to activate the security context of the active 3GPP connection on the non-3GPP connection. The UE lost the second NAS Count pair associated with the non-3GPP connection via the first PLMN because it was replaced with the third NAS Count pair associated with the non-3GPP connection via the second PLMN, the reconnection to the first PLMN will fail since the UE does not know if the security context received from the AMF of the first PLMN is valid.

According to some exemplary embodiments, a UE deregisters its non-3GPP connection with the first PLMN when it establishes a non-3GPP connection with a second PLMN. In some cases, the UE deregisters its current non-3GPP connection if that connection has been idle for longer than a predetermined time period. In other scenarios, the UE will communicate with the AMF of the first PLMN to deregister its non-3GPP connection with the first PLMN when the UE moves its non-3GPP connection to a second PLMN.

According to other exemplary embodiments, the AMF of a PLMN transmits to the UE a stored NAS Count pair previously established for a non-3GPP connection when the UE seeks to reestablish the non-3GPP connection with the PLMN. The UE then determines how to handle the received AMF NAS Count pair based on whether or not the UE has a corresponding stored NAS Count pair and, if it does, on whether or not the stored NAS Count pair is the same as the received AMF NAS Count pair.

According to further exemplary embodiments, when the UE seeks to register both types of connections (3GPP and non-3GPP) with a PLMN and only has one NAS Count pair corresponding to one of the connections stored on its USIM, the UE performs a primary authentication with the AMF of the PLMN to derive a new security context for both types of connections. According to further exemplary embodiments, the UE may store multiple NAS security contexts for multiple PLMNs locally or on the USIM.

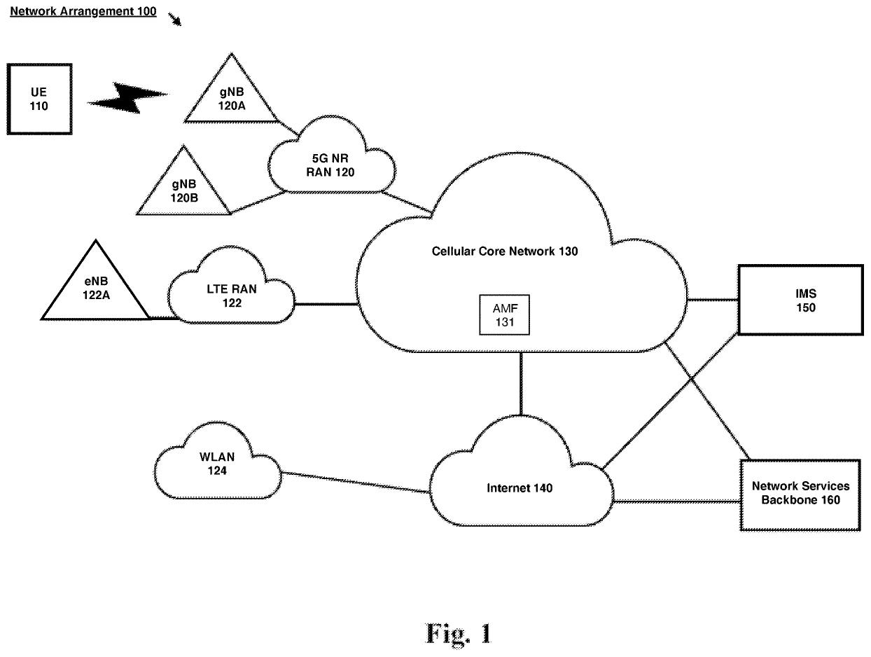

FIG. 1 shows an exemplary network arrangement 100 according to various exemplary embodiments. The exemplary network arrangement 100 includes a UE 110. It should be noted that any quantity of UEs may be used in the network arrangement 100. Those skilled in the art will understand that the UE 110 may alternatively be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any quantity of UEs being used by any quantity of users. Thus, the quantity of a single UE 110 is merely provided for illustrative purposes.

The UE 110 may be configured to communicate with one or more networks. In the example of the network configuration 100, the networks with which the UE 110 may wirelessly communicate are a 5G New Radio (NR) radio access network (5G NR-RAN) 120, an LTE radio access network (LTE-RAN) 122 and a wireless local access network (WLAN) 124. However, it should be understood that the UE 110 may also communicate with other types of networks and the UE 110 may also communicate with networks over a wired connection. Therefore, the UE 110 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UE that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via the gNB 120A and/or the gNB 120B. During operation, the UE 110 may be within range of a plurality of gNBs. Thus, either simultaneously or alternatively, the UE 110 may connect to the 5G NR-RAN 120 via the gNBs 120A and 120B. Further, the UE 110 may communicate with the eNB 122A of the LTE-RAN 122 to transmit and receive control information used for downlink and/or uplink synchronization with respect to the 5G NR-RAN 120 connection.

Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., the gNB 120A of the 5G NR-RAN 120).

In addition to the networks 120, 122 and 124 the network arrangement 100 also includes a cellular core network 130, the Internet 140, an IP Multimedia Subsystem (IMS) 150, and a network services backbone 160. The cellular core network 130 also manages the traffic that flows between the cellular network and the Internet 140. The cellular core network 130 may be considered to be the interconnected set of components that manages the operation and traffic of the cellular network. In this example, the components include an access and mobility management function (AMF) 131. However, an actual cellular core network may include various other components performing any of a variety of different functions.

The AMF 131 performs operations related to mobility management such as, but not limited to, paging, non-access stratum (NAS) management and registration procedure management between the UE 110 and the cellular core network 130. Reference to a single AMF 131 is merely for illustrative purposes, an actual network arrangement may include any appropriate number of AMFs.

As described above, the UE 110 may also establish a non-3GPP connection (e.g., WiFi connection) via the 5G NR-RAN 120. In such scenarios, a non-3GPP access network (e.g., WLAN 124) may be connected to the cellular core network 130. The control-plane functions and the user-plane functions of the cellular core network 130 may then be used for the UE 110 to access functionalities of the non-3GPP connection, e.g., accessing a data network.

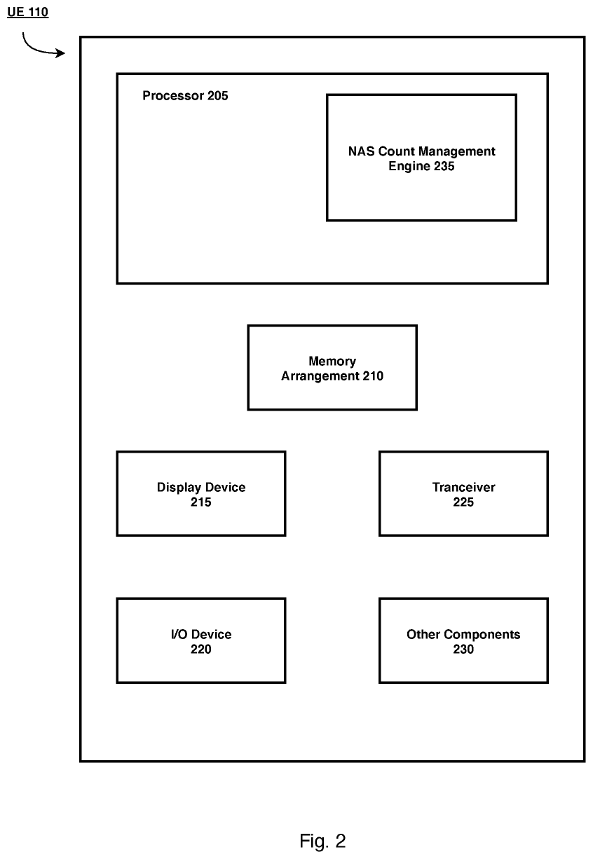

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225 and other components 230. The other components 230 may include, for example, an audio input device, an audio output device, a battery that provides a limited power supply, a data acquisition device, ports to electrically connect the UE 110 to other electronic devices, one or more antenna panels, etc. For example, the UE 110 may be coupled to an industrial device via one or more ports.

The processor 205 may be configured to execute a plurality of engines of the UE 110. For example, the engines may include NAS Count management engine 235. As will be described in more detail below, the NAS Count management engine 235 may perform various operations related to managing registrations of 3GPP and non-3GPP connections to one or more PLMNs.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UE, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122, the WLAN 124, etc. Accordingly, the transceiver 225 may operate on a variety of different frequencies or channels (e.g., set of consecutive frequencies).

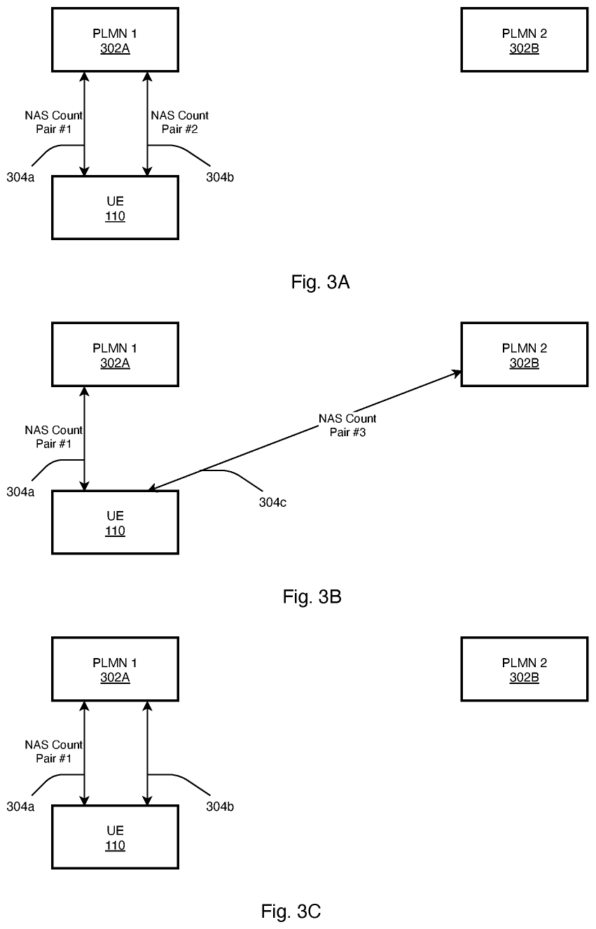

FIGS. 3A-3C show diagrams illustrating a UE establishing multi-connection access to PLMNs according to various exemplary embodiments. FIGS. 3A-3C illustrate the progression of steps as the UE 110 transitions one of its connections from a first PLMN 302A to a second PLMN 302B and back to the first PLMN 302A.

As illustrated in FIG. 3A, the UE 110 establishes a first type of connection 304a and a second type of connection 304b with a first PLMN 302A. In some embodiments, the first type of connection 304a is a 3GPP connection (e.g., a 5G wireless connection) and the second type of connection 304b is a non-3GPP connection (e.g., a WiFi connection). Because both types of connections 304a and 304b are to the same PLMN, the connections may share a common NAS security context having a common AMF security key (K_{AMF}). The NAS security context includes a first NAS count pair associated with uplink (UL) and downlink (DL) communications of the first type of connection 304a and a second NAS Count pair associated with the UL and DL communications of the second type of connection 304b.

As illustrated in FIG. 3B, at a later time, the UE 110 may establish a second type of connection 304c (e.g., non-3GPP) to a different PLMN (second PLMN 302B). As a result, the UE 110 now has the first type of connection 304a to the first PLMN 302A and the second type of connection 304c to the second PLMN 302B. Because the second type of connection (e.g., non-3GPP connection) is now with a different PLMN, a new NAS security context having a third NAS Count pair is established. Based on the current 3GPP standards (3GPP TS 31.102), because the UE 110 now has the third NAS Count pair, the second NAS Count pair may be deleted.

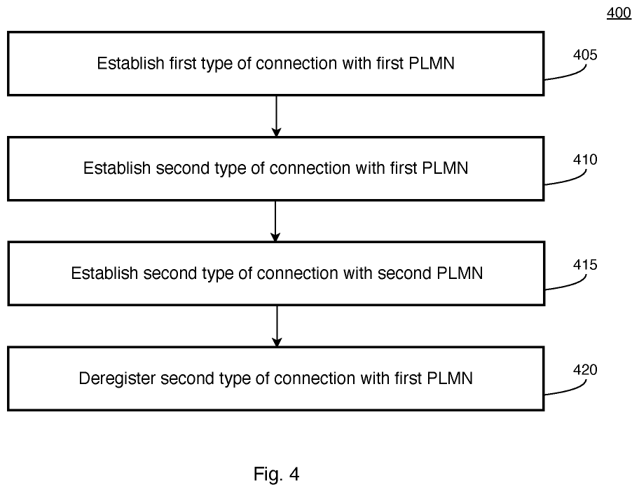

As illustrated in FIG. 3C, the UE 110 attempts to reestablish the second type of connection 304b with the first PLMN 302A. The following discussion with respect to FIGS. 4-7 describes how the UE 110 reestablishes this second type of connection 304b with the first PLMN 302A.

FIG. 4 shows a method 400 of managing a non-3GPP connection according to various exemplary embodiments. At 405, the UE 110 establishes a first type of connection 304a (e.g., a 3GPP connection) with the first PLMN 302A, as illustrated in FIG. 3A. At 410, the UE 110 establishes a second type of connection 304b (e.g., a non-3GPP connection) with the first PLMN 302A, as also illustrated in FIG. 3A. At 415, the UE 110 establishes a second type of connection 304c (e.g., non-3GPP) with a second PLMN 302B, as illustrated in FIG. 3B. At 420, the UE 110 deregisters the second type of connection 304b that it had with the first PLMN 302A. Because the UE 110 explicitly deregisters the second type of connection 304b, the AMF 131 will not try to reestablish this connection using the same NAS security context as the first type of connection 304a when the UE 110 tries to reestablish this connection. Instead, when the UE 110 attempts to reestablish the second type of connection 304b, the UE 110 re-registers with the AMF 131 of the first PLMN 302A.

In some embodiments, the deregistration in 420 is based on a predetermined time period during which the UE 110 has entered an idle mode for the second type of connection (non-3GPP). For example, if the UE 110 has entered an idle mode in the second type of connection 304b, with the first PLMN 302A, the UE 110 will deregister this connection.

In some embodiments, either the UE 110 or the AMF 131 may deregister the second type of connection 304b. In some embodiments, the UE 110 transmits a deregistration request to the AMF 131 of the first PLMN 302A to deregister the second type of connection 304b when the UE 110 establishes a second type of connection 304c with the second PLMN 302B. This deregistration request may be sent over the first type of connection 304a, which is still active when the UE 110 establishes its second type of connection 304c with the second PLMN 320B. In some embodiments, the AMF 131 of the first PLMN 302A may alternatively deregister the UE's second type of connection 304b with the first PLMN 302A in response to an indication sent by the UE 110. In some embodiments, the indication may be sent by the UE 110 over the first type of connection 304a and causes the AMF 131 to initiate the deregistration procedure.

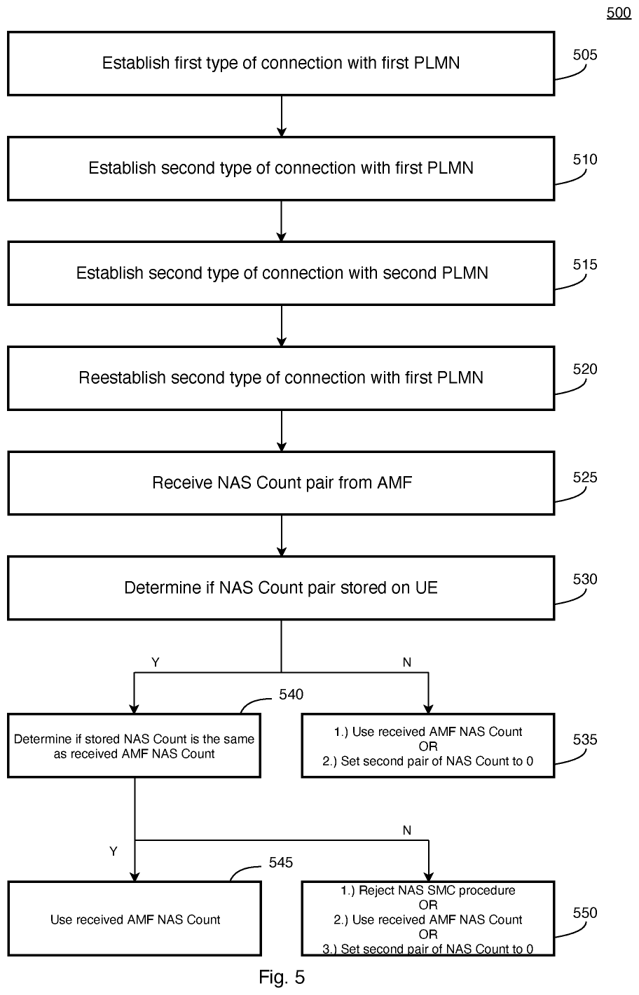

FIG. 5 shows a method 500 of managing a NAS Count pair associated with a non-3GPP connection according to various exemplary embodiments. At 505, the UE 110 establishes a first type of connection 304a (e.g., a 3GPP connection) with the first PLMN 302A, as illustrated in FIG. 3A. At 510, the UE 110 establishes a second type of connection 304b (e.g., a non-3GPP connection) with the first PLMN 302A, as also illustrated in FIG. 3A. At 515, the UE 110 establishes a second type of connection 304c (e.g., non-3GPP) with a second PLMN 302B, as illustrated in FIG. 3B. At 520, the UE 110 attempts to reestablish the second type of connection 304b with the first PLMN 302A. In response, at 525, the UE 110 receives the second NAS Count pair from the AMF 131 of the first PLMN 302A. In some embodiments, the second NAS Count pair is sent by the AMF 131 in a security mode command (SMC). The second NAS Count pair is stored on the AMF 131 of the first PLMN 302A and corresponds to the NAS security context being used for the active first type of connection 304a that the UE 110 still has with the first PLMN 302A. At 530, the UE 110 determines if it has a stored NAS Count pair corresponding to the NAS security context of the first type of connection 304a.

If the UE 110 does not have a stored NAS count pair corresponding to the NAS security context of the first type of connection 304a, then, at 535, the UE 110 either adopts the second NAS Count pair received from the AMF to reestablish the second type of connection 304b or sets the second NAS Count pair to 0 (resets the NAS Count) to reestablish the second type of connection 304b.

If, however, the UE 110 does have a stored NAS count pair corresponding to the NAS security context of the first type of connection 304a, then, at 540, the UE 110 determines if the stored NAS Count pair is equivalent to the second NAS Count pair received from the AMF 131. If the stored NAS Count pair is equivalent to the second NAS Count pair received from the AMF, then, at 545, the UE 110 adopts the second NAS Count pair received from the AMF 131 to reestablish the second type of connection 304b. If, however, the stored NAS Count pair is not equivalent to the second NAS Count pair received from the AMF 131, then, at 550, the UE 110 does one of the following to reestablish the second type of connection 304b: 1) rejects the NAS SMC procedure in which the received NAS Count pair was sent; 2) adopts the second NAS Count pair received from the AMF, or 3) sets the second NAS Count pair to 0 (resets the NAS Count).

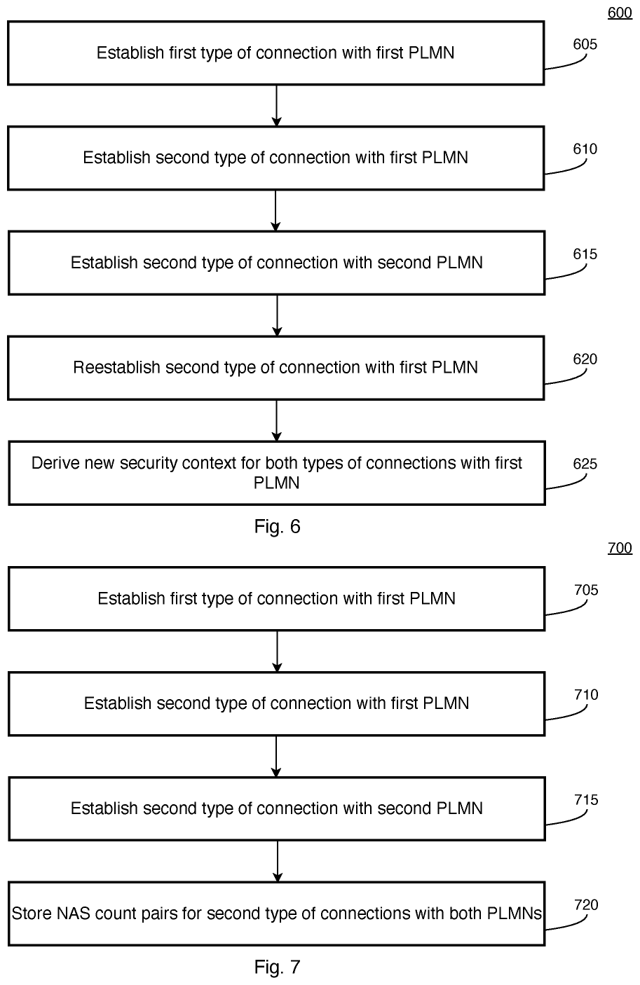

FIG. 6 shows a method 600 of managing a UE's multi-connection access to a PLMN according to various exemplary embodiments. At 605, the UE 110 establishes a first type of connection 304a (e.g., a 3GPP connection) with the first PLMN 302A, as illustrated in FIG. 3A. At 610, the UE 110 establishes a second type of connection 304b (e.g., a non-3GPP connection) with the first PLMN 302A, as also illustrated in FIG. 3A. At 615, the UE 110 establishes a second type of connection 304c (e.g., non-3GPP) with a second PLMN 302B, as illustrated in FIG. 3B. At 620, the UE 110 tries to reestablish the second type of connection 304b with the first PLMN 302A. When the UE 110 tries to reestablish this connection and detects only one stored NAS Count pair for only one type of connection (first or second), at 625, the UE 110 performs a primary authentication with the AMF 131 of the first PLMN 302A and derives a new security context for both the first type of connection 304a and the second type of connection 304b. As a result, the UE 110 will receive two new NAS Count pairs, each one corresponding to one type of connection.

FIG. 7 shows a method 700 of managing a plurality of NAS Count pairs according to various exemplary embodiments. At 705, the UE 110 establishes a first type of connection 304a (e.g., a 3GPP connection) with the first PLMN 302A, as illustrated in FIG. 3A. At 710, the UE 110 establishes a second type of connection 304b (e.g., a non-3GPP connection) with the first PLMN 302A, as also illustrated in FIG. 3A. At 715, the UE 110 establishes a second type of connection 304c (e.g., non-3GPP) with a second PLMN 302B, as illustrated in FIG. 3B. At 720, the UE 110 stores the NAS Count pairs for both the second type of connection 304b with the first PLMN 302A and the second type of connection 304c with the second PLMN 302B. As a result, the UE 110 avoids the failure of the reestablishment of the second type of connection 304b with the fist PLMN 302A. In some embodiments, the UE 110 stores the multiple NAS count pairs on its USIM. In some embodiments, the UE 110 may alternatively store the multiple NAS count pairs locally on the UE itself.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A user equipment (UE), comprising:
a transceiver configured to communicate with a plurality of networks; and
a processor communicatively coupled to the transceiver and configured to perform operations comprising:
establishing a first type of connection to a first public land mobile network (PLMN), the first type of connection having a first non-access stratum (NAS) Count pair corresponding to a first NAS security context associated with the first PLMN;
establishing a second type of connection to a second PLMN, wherein a previous second type of connection was established with the first PLMN, wherein the previous second type of connection has a second NAS Count pair corresponding to the first NAS security context, wherein the second type of connection has a third NAS Count pair corresponding to a second NAS security context associated with the second PLMN; and
deregistering the previous second type of connection with the first PLMN to reset the second NAS count pair at the first PLMN.

2. The UE of claim 1, wherein the first type of connection is a 3^{rd} generation partnership project (3GPP) wireless connection and the second type of connection is a non-3GPP wireless connection.

3. The UE of claim 1, wherein deregistration of the previous second type of connection comprises:
transmitting a deregistration request to an access and mobility management function (AMF) of the first PLMN upon establishment of the second type of connection to the second PLMN,
wherein the deregistration request s transmitted over the first type of connection with the first PLMN.

4. The UE of claim 1, wherein deregistration of the previous second type of connection comprises:
transmitting a request to an AMF of the first PLMN that triggers the AMF to initiate a deregistration procedure,
wherein the request is transmitted over the first type of connection with the first PLMN.

5. A user equipment (UE), comprising:
a transceiver configured to communicate with a plurality of networks; and
a processor communicatively coupled to the transceiver and configured to perform operations comprising:
establishing a first type of connection to a first public land mobile network (PLMN), wherein the first type of connection has a first non-access stratum (NAS) Count pair corresponding to a NAS security context associated with an access and mobility management function (AMF) of the first PLMN;
reestablishing a second type of connection to the first PLMN after previously transitioning the second type of connection to a second PLMN; and
receiving a second NAS Count pair from an AMF of the first PLMN, wherein the second NAS count pair corresponds to the second type of connection.

6. The UE of claim 5, wherein the first type of connection is a 3^{rd} generation partnership project (3GPP) wireless connection and the second type of connection is a non-3GPP wireless connection.

7. The UE of claim 6, wherein, when the UE does not have a stored second NAS count pair or when the UE has a stored second NAS count pair different than the second NAS count pair received from the AMF of the first PLMN, the operations further comprise:
adopting the second NAS Count pair received from the AMF of the first

8. The UE of claim 6, wherein, when the UE does not have a stored second NAS count pair or when the UE has a stored second NAS count pair different than the second NAS count pair received from the AMF of the first PLMN, the operations further comprise:
setting a second NAS Count pair associated with the second type of connection to zero.

9. The UE of claim 6, wherein, when the UE does not have a stored second NAS count pair or when the UE has a stored second NAS count pair different than the second NAS count pair received from the AMF of the first PLMN, the operations further comprise:
rejecting a NAS security mode command (SMC) from the AMF of the first PLMN including the second NAS Count pair.

10. The UE of claim 6, wherein, when the UE has a stored second NAS count pair, the operations further comprise:
determining if the stored second NAS Count pair is equivalent to the second NAS Count pair received from the AMF of the first PLMN.

11. The UE of claim 9, wherein, when the UE determines that the stored second NAS Count pair is equivalent to the second NAS Count pair received from the AMF of the first PLMN, the operations further comprise:
adopting the second NAS Count pair received from the AMF of the first PLMN to reestablish the second type of connection with the first PLMN.

12. A user equipment (UE), comprising:
a transceiver configured to communicate with a plurality of networks; and
a processor communicatively coupled to the transceiver and configured to perform operations comprising:
establishing a first type of connection to a first public land mobile network (PLMN), wherein the first type of connection has a first non-access stratum (NAS) Count pair corresponding to a NAS security context associated with the access and mobility management function (AMP) of the first PLMN;
reestablishing a second type of connection to the first PLMN after previously transitioning the second type of connection to a second PLMN; and
determining a new security context for both the first type of connection and the second type of connection.

13. The UE of claim 12, wherein the first type of connection is a 3^{rd} generation partnership project (3GPP) wireless connection and the second type of connection is a non-3GPP wireless connection.

14. The UE of claim 13, wherein the new security context is determined when the UE determines that the UR only has one NAS Count pair corresponding to one of the first type of connection or the second type of connection.

15-25. (canceled)
